(19) United States
(12) Patent Application Publication
(10) Pub. No.: US 2011/0134671 A1
(43) Pub. Date: Jun. 9, 2011

(54) AC/DC CONVERTER PRELOADING CIRCUIT

(75) Inventor: Didier BALOCCO, Lannion (FR)

(73) Assignee: AEG POWER SOLUTIONS B.V., Ah Zwanenburg (NL)

(21) Appl. No.: 12/958,854

(22) Filed: Dec. 2, 2010

(30) Foreign Application Priority Data
Dec. 3, 2009 (FR) 0958616

(51) Int. Cl. H02M 7/06

(52) U.S. Cl. 363/126

(57) ABSTRACT

In an AC/DC converter a preloading circuit is provided for a bridgeless boost converter, including a first diode D1 having its anode connected to a first AC input terminal of the AC/DC converter and having its cathode connected to a first DC output terminal of the AC/DC converter, a second diode D2 having its anode connected to a second AC input terminal of the AC/DC converter and having its cathode connected to the first DC output terminal of the AC/DC converter, a first switch S1 having one end connected to said first AC input terminal of the AC/DC converter and having its other end connected to a second DC output terminal of the AC/DC converter, and a second switch S2 having one end connected to said second AC input terminal of the AC/DC converter and having its other end connected to said second DC output terminal of the AC/DC converter.

### FIELD OF THE INVENTION

The present invention relates to the field of AC/DC power converters and more particularly to a protection circuit for preloading the output and its use to improve electromagnetic interference and efficiency in a bridgeless boost power factor correcting (PFC) converter.

### PRIOR ART

The use of AC/DC converters for transforming an alternating current (AC) supply, for example the mains supply, into a stabilized direct current (DC) voltage is well known in all industrial fields.

Among such converters, one of the most interesting configurations from the point of view of efficiency in relation conduction losses is the bridgeless boost PFC converter. However, eliminating the standard diode bridge makes this configuration particularly sensitive to current and voltage interruptions and overloads in the AC supply.

The international application WO2009/058024 proposes to shunt such a converter with a protection circuit formed of four diodes connected both to the AC supply and to the output of the converter. Unfortunately, adding this circuit is not free of drawbacks because, in some operating stages, notably when the current in one of the switching inductors of the converter becomes discontinuous, very high common mode voltages appear at the terminals of the diodes, creating undesirable electromagnetic interference (EMI).

### OBJECT AND DEFINITION OF THE INVENTION

An object of the present invention is to alleviate the drawbacks mentioned above with an AC/DC converter preloading circuit that greatly reduces electromagnetic interference in the converter. Another object of the invention is to avoid saturation of the switching inductors of the converter when the output is not loaded. A further object of the invention is to improve the efficiency of such a converter.

The above objects are achieved by a preloading circuit for a bridgeless boost converter including:
a first diode D1 having its anode connected to a first AC input terminal of said converter and having its cathode connected to a first DC output terminal of said converter; and
a second diode D2 having its anode connected to a second AC input terminal of said converter and having its cathode connected to said first DC output terminal;

further including:
a first switch S1 connected between said first AC input terminal and a second DC output terminal of said converter; and
a second switch S2 connected between said second AC input terminal and said second DC output terminal.

With this specific configuration, the presence of the bidirectional switches makes it possible to reduce significantly the electromagnetic interference that is mainly produced during stages in which the current in one of the switching inductors of the converter is discontinuous.

Said first and second switches are advantageously metal oxide on silicon field effect transistors (MOSFETs).

The present invention also provides an AC/DC converter including a bridgeless boost converter and the above preloading circuit.

### BRIEF DESCRIPTION OF THE DRAWINGS

The features and advantages of the present invention emerge more clearly from the following description given by way of non-limiting illustration and with reference to the appended drawings, in which:

FIG. 1 shows a first example of an AC/DC converter including a preloading circuit of the invention;

FIGS. 1A to 1C show variants of the AC/DC converter from FIG. 1 with a preloading current limiter circuit added to it; and

FIG. 2 shows various phases in the control of the switches of the FIG. 1 converter and its associated preloading circuit.

### DETAILED DESCRIPTION OF A PREFERRED EMBODIMENT

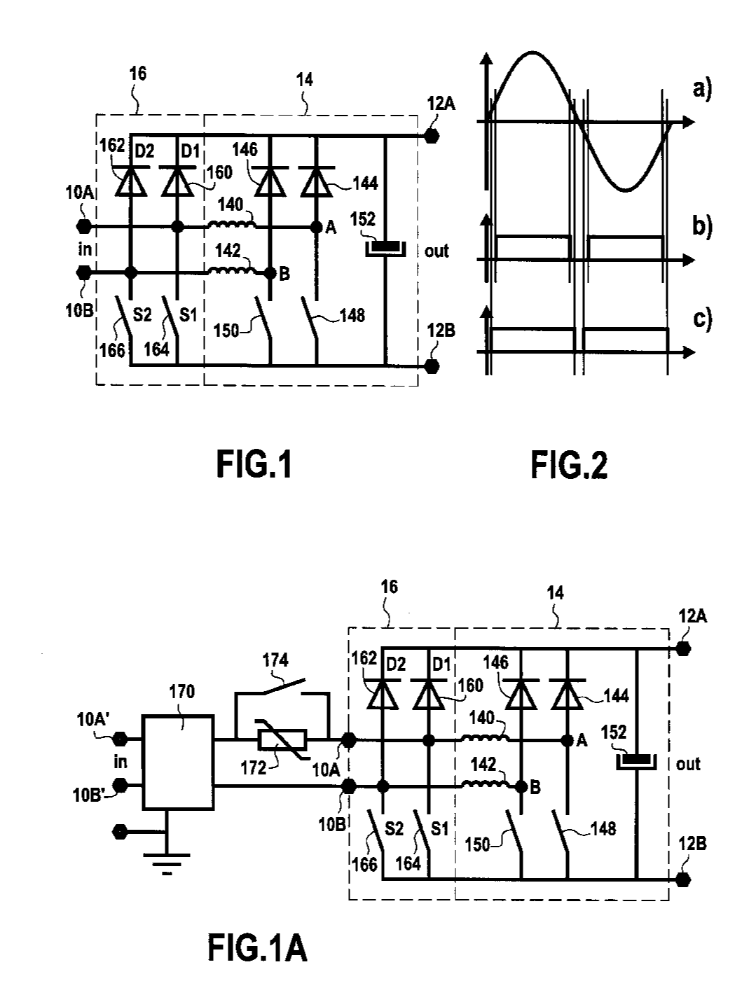

FIG. 1 shows a first example of an AC/DC converter 10 having two AC input terminals 10A, 10B and two DC output terminals 12A, 12B and including a bridgeless boost PFC converter 14 and a preloading circuit 16 of the invention.

The bridgeless boost PFC converter conventionally includes: a first inductor 140, having one end connected to the first AC input terminal 10A and its other end connected to a first node A, a second inductor 142, having one end connected to the second AC input terminal 10B and its other end connected to a second node B, a first rectifier diode 144 having its anode connected to the first node A and having its cathode connected to the first DC output terminal 12A, a second rectifier diode 146 having its anode connected to the second node B and having its cathode connected to the first DC output terminal 12A, a first chopper switch 148 connected between the first node A and the second DC output terminal 12B, a second chopper switch 150 connected between the second node B and the second DC output terminal 12B, and a reservoir capacitor 152 connected between the two DC output terminals 12A, 12B.

According to the invention, the preloading circuit includes a first protection diode D1 160 having its anode connected to the first AC input terminal 10A and having its cathode connected to the first DC output terminal 12A, a second protection diode D2 162 having its anode connected to the second AC input terminal 10B and having its cathode connected to the first DC output terminal 12A, a first protection switch S1 164 connected between the first AC input terminal 10A and the second DC output terminal 12B, and a second protection switch S2 166 connected between the second AC input terminal 10B and the second DC output terminal 12B.

In another embodiment shown in FIG. 1A and including a preloading current limiter circuit, the first and second AC input terminals 10A, 10B of the AC/DC converter are not connected to the terminals 10A′, 10B′ of the AC supply, for example the mains supply, directly but via an EMI filter 170 and an inrush current limiter circuit formed by a resistor 172, possibly a variable resistor, shunted by a switch 174, which is difficult to control because of its floating nature. The EMI filter is connected directly to the AC supply terminals 10A′, 10B′, whereas the limiter circuit is connected in series to the output of the EMI filter in one of the connections of this EMI filter to the input of the AC/DC converter.

FIGS. 1B and 1C show two variants of the FIG. 1A embodiment in which the limiter circuit 170, 172 is now placed not at the input of the AC/DC converter but at its output and in series with one or the other of the DC output terminals 12A, 12B, an additional capacitor 176 on the downstream side in parallel with these two output terminals then being necessary to filter the switching current.

In the FIG. 1B structure, the preloading current of the capacitor 176 is not controlled. This capacitor must therefore be of low capacitance. The opening and closing conditions in respect of the switch 174 are easier to determine, but it is still floating so controlling it is still difficult. However, this variant has the advantage of not breaking the negative common point 12B between the two capacitors 176 and 152.

The preloading current of the capacitor 176 is not controlled in the FIG. 1C structure either. This capacitor must therefore also be of low capacitance. However, the opening and closing conditions in respect of the switch 174 are easier to determine and it is now easy to control because it is connected to the same potential as the other switches 148, 150, 164, and 166 of the converter. However, this other variant has the drawback that it breaks the negative common point between the two capacitors 176 and 152, which may impact seriously on electromagnetic interference.

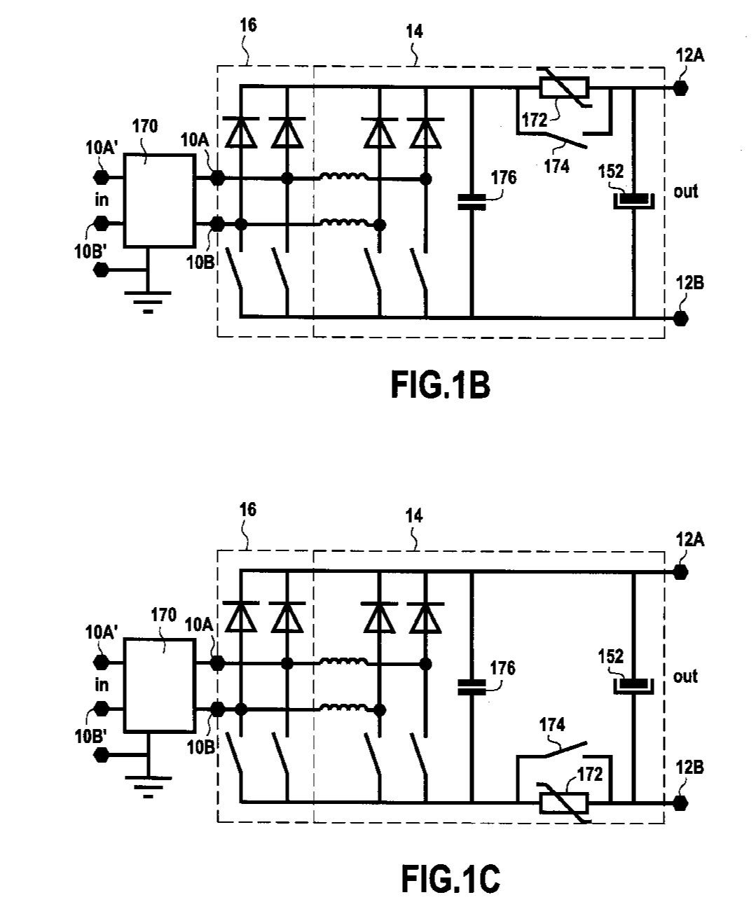

The operation of the converter and the preloading circuit of the invention (providing the return path for the current) are described below with reference to FIG. 2, which shows various stages of operation under steady state conditions.

Note that in normal operation the return current, always chooses the path of lowest impedance, and therefore flows for the most part through the protection switches S1 or S2 of the preloading circuit rather than through the pair of inductors 140 or 142 and the chopper switches 148 or 150 of the converter.

In the positive half-cycle (positive at the terminal 10A and negative at the terminal 10B) of the AC voltage (curve a), switching is effected by the first chopper switch 148 (curve b), the first inductor 140, and the first rectifier diode 144. The state of the second chopper switch 150 is not relevant to this switching. The return current to the terminal 10B flows for the most part through the second protection switch 166, which is permanently conducting (curve c). A small portion of the return current flows through the second inductor 142 and the second chopper switch 150. Using the second protection switch 166 improves efficiency compared to using a single diode as S2. To improve efficiency further, it is also possible for the second chopper switch 150 to conduct at the same time as the second protection switch 166. In contrast, to prevent the occurrence of a common mode voltage, and thus the creation of electromagnetic interference, this second protection switch 166 must be activated before chopping by the first chopper switch 148. Similarly, the second protection switch 166 remains active after the end of chopping by the first chopper switch 148.

During the negative half-cycle (negative at the terminal 10A and positive at the terminal 10B) of the AC voltage (curve a), switching is effected by the second chopper switch 150 (curve b), the second inductor 142, and the second rectifier diode 146. The state of the first chopper switch 148 is not relevant to this switching. The return current to the terminal 10A flows for the most part via the first protection switch 164, which is permanently conducting (curve c). A small portion of the return current also flows through the first inductor 140 and the first chopper switch 148. Using the first protection switch 164 improves efficiency compared to using a single diode as the switch S1. To improve efficiency further, it is also possible for the first chopper switch 148 to conduct at the same time as the first protection switch 164. In contrast, to avoid the occurrence of common-mode voltages, and thus the creation of electromagnetic interference, the first protection switch 164 must be activated before chopping by the second chopper switch 150. Similarly, the first protection switch 164 remains active after the end of chopping by the second chopper switch 150.

In contrast, when the AC voltage (curve a) is close to zero, the first and second protection switches S1 and S2 are open (to prevent a short circuit). Because the first and second chopper switches 148, 150 of the converter are also stopped during this period, there is no further chopping and thus no further noise caused by electromagnetic interference. This has little impact on the efficiency of the converter and/or the form factor of the input current because when the voltage is close to zero the energy transfer is very low and contributes little to the overall performance of the converter.

Thus the preloading circuit of the invention has a structure that is particularly simple with reduced overall size, rendering it applicable to multiple AC/DC converter configurations. Moreover, the addition of the current limiter circuit on the upstream or downstream side makes it possible to set the maximum amplitude of the preloading current.

What is claimed is:

1. An AC/DC converter including:
a bridgeless boost converter; and
a preloading circuit including:
a first diode D1 having its anode connected to a first AC input terminal of the AC/DC converter and having its cathode connected to a first DC output terminal of the AC/DC converter; and
a second diode D2 having its anode connected to a second AC input terminal of the AC/DC converter and having its cathode connected to said first DC output terminal of the AC/DC converter;
wherein said preloading circuit further includes:
a first switch S1 having one end connected to said first AC input terminal of the AC/DC converter and having its other end connected to a second DC output terminal of the AC/DC converter; and
a second switch S2 having one end connected to said second AC input terminal of the AC/DC converter and having its other end connected to said second DC output terminal of the AC/DC converter.

2. An AC/DC converter according to claim 1, wherein said first and second switches are MOSFETs.

3. An AC/DC converter according to claim 1, further including an inrush current limiter circuit connected in series via said AC input terminal or said DC output terminal.

4. A preloading circuit for a bridgeless boost converter including:
a first diode D1 having its anode connected to a first AC input terminal of the AC/DC converter and having its cathode connected to a first DC output terminal of the AC/DC converter; and
a second diode D2 having its anode connected to a second AC input terminal of the AC/DC converter and having its cathode connected to said first DC output terminal of the AC/DC converter;
which preloading circuit further includes:
a first switch S1 having one end connected to said first AC input terminal of the AC/DC converter and having its other end connected to a second DC output terminal of the AC/DC converter; and
a second switch S2 having one end connected to said second AC input terminal of the AC/DC converter and having its other end connected to said second DC output terminal of the AC/DC converter.

5. A preloading circuit according to claim 4, wherein said first and second switches are MOSFETs.
